(19) United States
(12) Patent Application Publication
(10) Pub. No.: US 2026/0193023 A1
(43) Pub. Date: Jul. 9, 2026

(54) DRIVING MECHANISM FOR TRASH CAN

(71) Applicant: EKO GROUP LTD, Jiangmen (CN)

(72) Inventor: Yizhi CHEN, Jiangmen (CN)

(21) Appl. No.: 19/553,552

(22) Filed: Mar. 2, 2026

(30) Foreign Application Priority Data
Sep. 8, 2025 (CN) 202521934191.9

(51) Int. Cl. B65F 1/06; B65B 51/14; B65F 1/14

(52) U.S. Cl. CPC B65F 1/06; B65B 51/146; B65F 1/14

(57) ABSTRACT

A driving mechanism for a trash can, including a frame assembly, a driving assembly, a gathering assembly and a transmission assembly. The driving assembly includes a motor, a lead screw and a lead screw nut. The motor is connected to the lead screw. The lead screw nut is threadedly connected to the lead screw, and is connected to the frame assembly. The transmission assembly and the driving assembly are arranged spaced apart from each other. The transmission assembly includes a worm gear inside the frame assembly and a worm drivably connected to the motor. The motor is configured to drive the worm to rotate to cause the worm gear to rotate, so as to drive the gathering assembly to gather a trash bag. The frame assembly is configured to drive the worm gear to reciprocate along the worm.

### CROSS-REFERENCE TO RELATED APPLICATIONS

This application claims the benefit of priority from Chinese Patent Application No. 202521934191.9, filed on September 8, 2025. The content of the aforementioned application, including any intervening amendments made thereto, is incorporated herein by reference in its entirety.

### TECHNICAL FIELD

This application relates to trash cans, and more particularly to a driving mechanism for a trash can.

### BACKGROUND

Current trash cans often require multiple power sources to cooperate to gather a trash bag during the garbage packaging process, and then adopts a heat-sealing mechanism installed in a fixed position to thermally seal the opening of the trash bag. Due to the presence of multiple power sources, the system complexity and cost are increased, and it is also accompanied by serious energy waste.

### SUMMARY

In view of this, an object of the disclosure is to provide a single power source-based driving mechanism for a trash can to overcome the defects in the prior art.

Technical solutions of the present disclosure are described as follows.

A driving mechanism for a trash can, comprising:

a frame assembly;

a driving assembly;

a gathering assembly; and

a first transmission assembly;

wherein the driving assembly comprises a motor, a lead screw and a lead screw nut;

the motor is connected to the lead screw;

the lead screw nut is threadedly connected to the lead screw, and is connected to the frame assembly;

the motor is configured to drive the lead screw to rotate to cause the lead screw nut to reciprocate along the lead screw, so as to drive the frame assembly to move along a first direction to approach a trash bag;

the gathering assembly is provided on the frame assembly along a second direction perpendicular to the first direction;

the first transmission assembly is arranged spaced apart from the driving assembly;

the first transmission assembly comprises a worm gear and a worm;

the worm is drivably connected to the motor;

the worm gear is sleeved on the worm, and is drivably connected to the gathering assembly;

the motor is configured to drive the worm to rotate to cause the worm gear to rotate, so as to drive the gathering assembly to gather and close the trash bag;

the worm gear is provided inside the frame assembly; and

the frame assembly is configured to drive the worm gear to reciprocate along the worm.

In some embodiments, the driving mechanism further comprises a second transmission assembly;

wherein a first end of the second transmission assembly is connected to the motor, and a second end of the second transmission assembly is connected to the lead screw; and

the second transmission assembly is drivably connected to the worm.

In some embodiments, the second transmission assembly comprises a transmission shaft and a transmission gear set;

a first end of the transmission shaft is connected to the motor, and a second end of the transmission shaft is connected to the lead screw;

the transmission gear set is sleeved outside the transmission shaft; and

the transmission gear set is drivably connected to the worm.

In some embodiments, the transmission gear set comprises a first transmission gear and a second transmission gear;

the first transmission gear is sleeved outside the transmission shaft;

the second transmission gear is provided at an end of the worm; and

the first transmission gear is engaged with the second transmission gear.

In some embodiments, the transmission shaft comprises a first connecting segment and a second connecting segment;

a diameter of the first connecting segment is greater than a diameter of the second connecting segment;

the first transmission gear is fixedly sleeved on the first connecting segment;

an end of the lead screw is provided with an insertion slot; and

the second connecting segment is configured to be inserted into the insertion slot.

In some embodiments, the driving assembly further comprises a connecting part and a connecting hole;

the connecting hole is configured to penetrate through the lead screw and the second connecting segment; and

the connecting part is insertedly provided in the connecting hole to fix the second connecting segment to the lead screw.

In some embodiments, the first transmission assembly further comprises a first bearing and a second bearing;

the first bearing and the second bearing are sleeved outside the worm;

the first bearing is provided at a first end of the worm gear, and the second bearing is provided at a second end of the worm gear; and

the first bearing is provided between the second transmission gear and the worm gear.

In some embodiments, the driving assembly further comprises a guide wheel; and the guide wheel is provided on the frame assembly.

Compared to the prior art, the present disclosure has the following beneficial effects.

In the present disclosure, the motor is configured to drive the lead screw to rotate, so as to drive the lead screw nut, the frame assembly and the worm gear to move along the first direction. The motor is also drivably connected to the worm, such that the worm is driven by the motor to rotate, thereby causing the worm gear to rotate. In this way, both reciprocating movement and rotation of the worm gear are achieved, enabling the gathering of the trash bag. By employing the motor as a single power source, the present disclosure, compared with conventional transmission systems having multiple power sources, has fewer power sources, simplified structure and reduced cost, and can effectively address the problem of energy waste, thereby conforming to the development tendency of energy saving and environmental protection.

### BRIEF DESCRIPTION OF THE DRAWINGS

In order to illustrate the technical solutions in the embodiments of the present disclosure or the prior art more clearly, the accompanying drawings needed in the description of the embodiments or prior art will be briefly described below. Obviously, presented in the accompanying drawings are only some embodiments of the present disclosure, and for those of ordinary skill in the art, other accompanying drawings can be obtained from the structures illustrated therein without making creative effort.

FIG. 1 is a structural diagram of a trash can according to an embodiment of the present disclosure;

FIG. 2 is a structural diagram of an accommodating chamber within the trash can according to an embodiment of the present disclosure;

FIG. 3 schematically shows an internal structure of an accommodating groove of the trash can according to an embodiment of the present disclosure;

FIG. 4 is a structural diagram of FIG. 3 without a frame assembly;

FIG. 5 is a structural diagram of a driving mechanism of the trash can according to an embodiment of the present disclosure;

FIG. 6 is a top view of FIG. 4;

FIG. 7 is an enlarged view of portion “A” in FIG. 6;

FIG. 8 schematically illustrates a positional relationship between an abutting mechanism and a heating part according to an embodiment of the present disclosure;

FIG. 9 is a structural diagram of the abutting mechanism according to an embodiment of the present disclosure;

FIG. 10 is a structural diagram of the heating part, a mounting portion and a first pushing ramp according to an embodiment of the present disclosure;

FIG. 11 is a structural diagram of the heating part and the mounting portion according to an embodiment of the present disclosure;

FIG. 12 is a structural diagram of a rear wheel and a second pushing ramp according to an embodiment of the present disclosure;

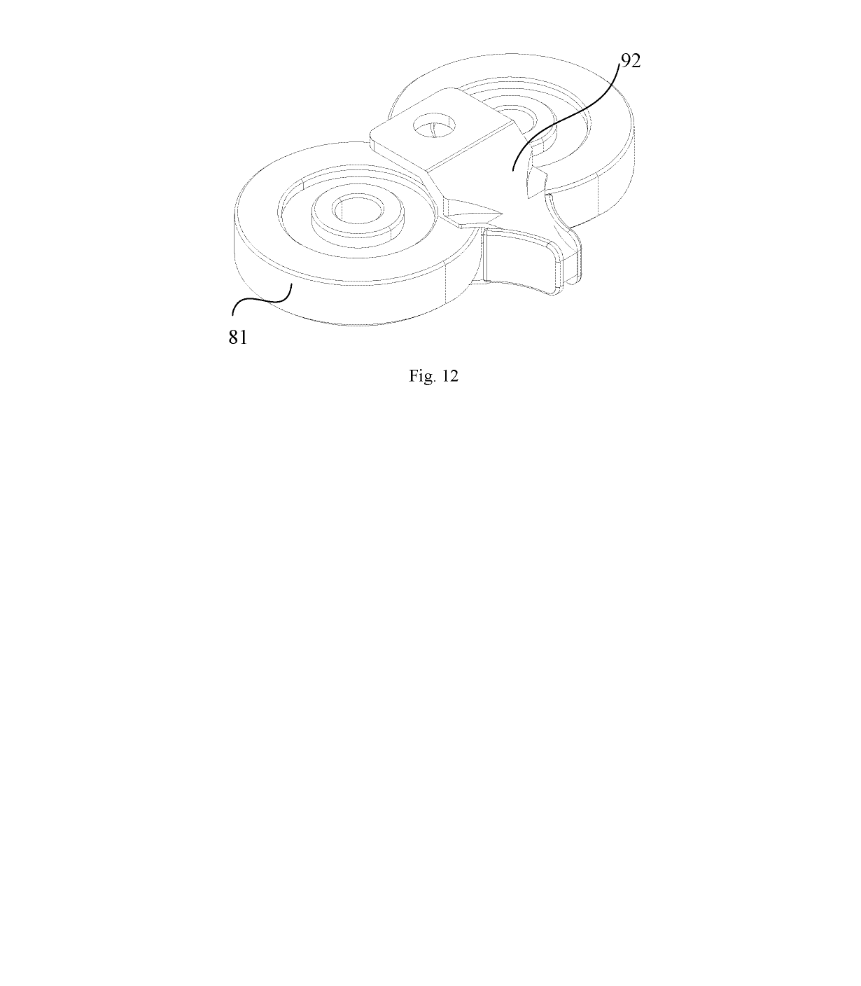

FIG. 13 is a structural diagram of the second pushing ramp according to an embodiment of the present disclosure;

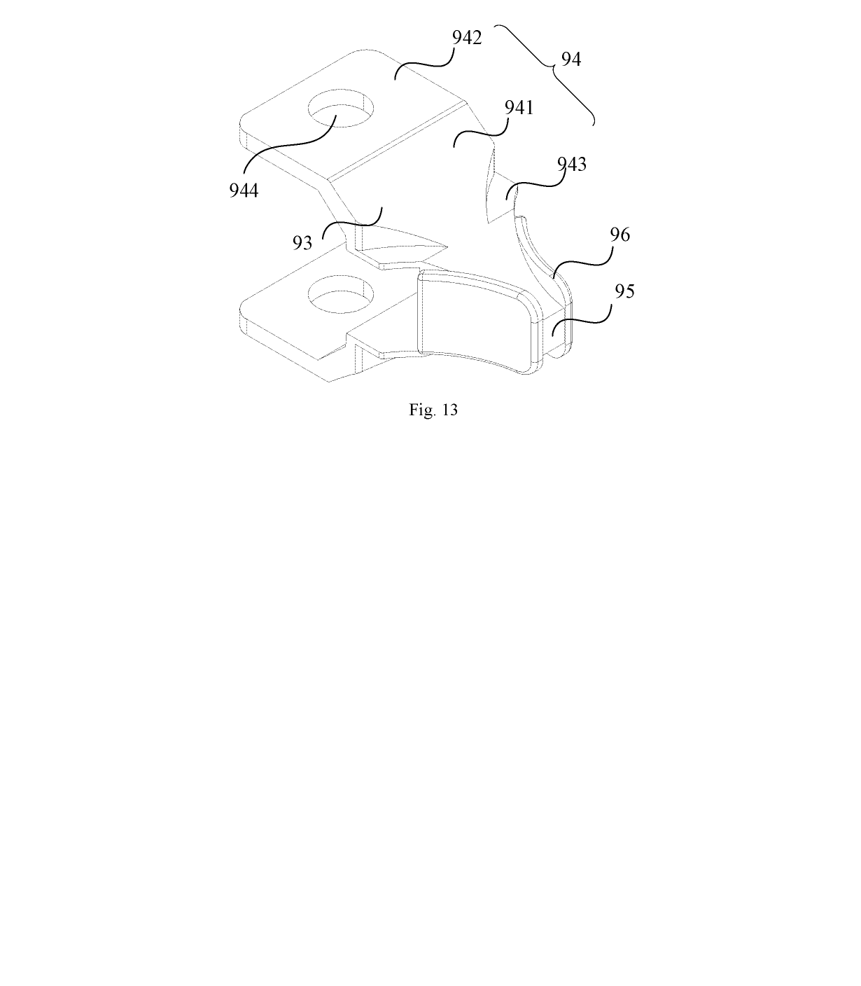

FIG. 14 is a structural diagram of a second transmission assembly according to an embodiment of the present disclosure;

FIG. 15 is a structural diagram of a lead screw according to an embodiment of the present disclosure; and

FIG. 16 structurally illustrates an engagement between a worm gear and the second transmission assembly according to an embodiment of the present disclosure.

In the figures: 1-trash can body; 11-accommodating groove; 12-accommodating chamber; 13-guide rail; 14-sensor; 15-return spring; 16-controller; 17-first direction; 18-second direction; 2-driving mechanism; 21-driving assembly; 211-motor; 212-second transmission assembly; 2121-transmission shaft; 2122-transmission gear set; 2123-first transmission gear; 2124-second transmission gear; 2125-first connecting segment; 2126-second connecting segment; 2127-connecting hole; 213-lead screw; 2131-insertion slot; 214-lead screw nut; 215-guide wheel; 22-first transmission assembly; 221-worm gear; 222-worm; 223-first bearing; 224-second bearing; 3-frame assembly; 31-first frame; 32-second frame; 33-third frame; 34-fourth frame; 4-first gathering assembly; 41-first contact region; 42-first driving wheel set; 43-first transmission belt; 44-first driving wheel; 45-second driving wheel; 46-third driving wheel; 47-tensioning wheel; 5-second gathering assembly; 51-second contact region; 52-second driving wheel set; 53-second transmission belt; 54-first transmission wheel; 55-second transmission wheel; 56-third transmission wheel; 6-heating part; 61-mounting portion; 62-abutting mechanism; 621-positioning portion; 622-protruding portion; 623-first edge; 624-second edge; 625-third edge; 63-first bending portion; 64-first heating portion; 65-second bending portion; 66-second heating portion; 7-synchronous pulley set; 71-first synchronous pulley; 72-second synchronous pulley; 73-synchronous belt; 74-idler gear; 8-rear wheel set; 81-rear wheel; 82-rear support block; 9-first pushing ramp; 91-first slope; 92-second pushing ramp; 93-second slope; 94-pushing arm; 941-pushing portion; 942-fixing portion; 943-clamping portion; 944-fixing hole; 95-connecting part; and 96-retaining edge.

The implementation, functional characteristics and advantages of the present disclosure will be further described in conjunction with the embodiments and accompanying drawings.

### DETAILED DESCRIPTION OF EMBODIMENTS

The technical solutions in the embodiments of the present disclosure will be described clearly and completely below in conjunction with the accompanying drawings. It is obvious that the described embodiments are merely some embodiments of the present disclosure, instead of all embodiments. Based on the embodiments in the present disclosure, all other embodiments obtained by those of ordinary skill in the art without making creative effort shall fall within the scope of the present disclosure.

It should be noted that all directional indications (such as up, down, left, right, front, and back) are used only for explaining the relative positional relationship or movement between the components in a particular attitude (as shown in the accompanying drawings), and the directional indications are correspondingly changed if the particular attitude is changed.

As used herein, terms such as “first” and “second” are only descriptive, and should not be construed as indicating or implying their relative importance or implicitly specifying the number of technical features indicated. As a result, a feature defined as “first” or “second” may include at least one of such features, either explicitly or implicitly. In addition, “and/or” includes three solutions, for example, “A and/or B” includes technical solution A, technical solution B, and a combination thereof. In addition, the technical solutions of various embodiments may be combined with each other on the premise that the combined solution can be implemented by those of ordinary skill in the art. When the combination of technical solutions appears to be contradictory or unimplementable, it should be understood that such a combination does not exist and is not included within the scope of the present disclosure.

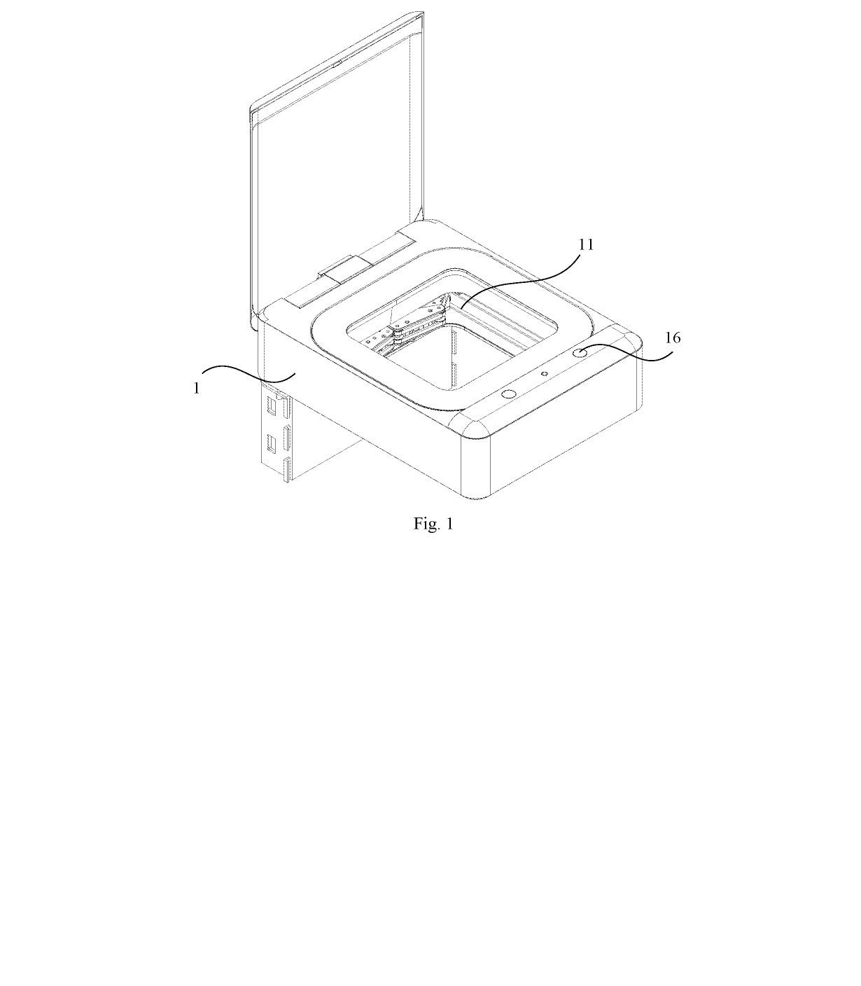

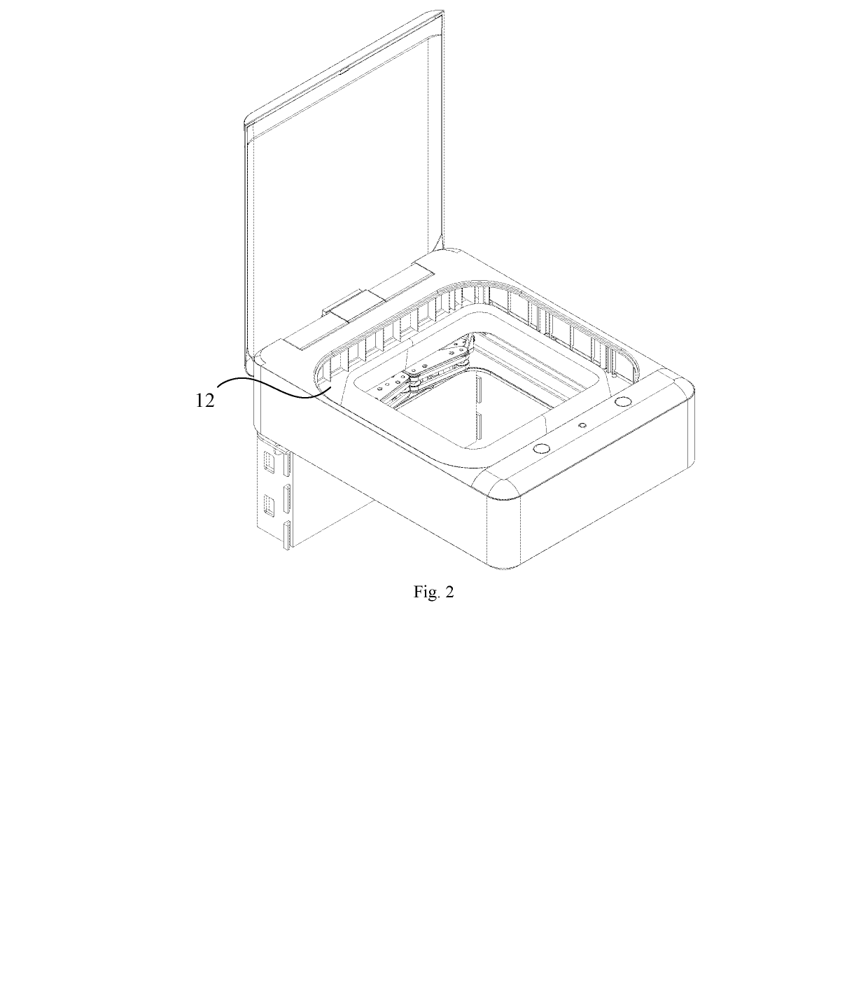

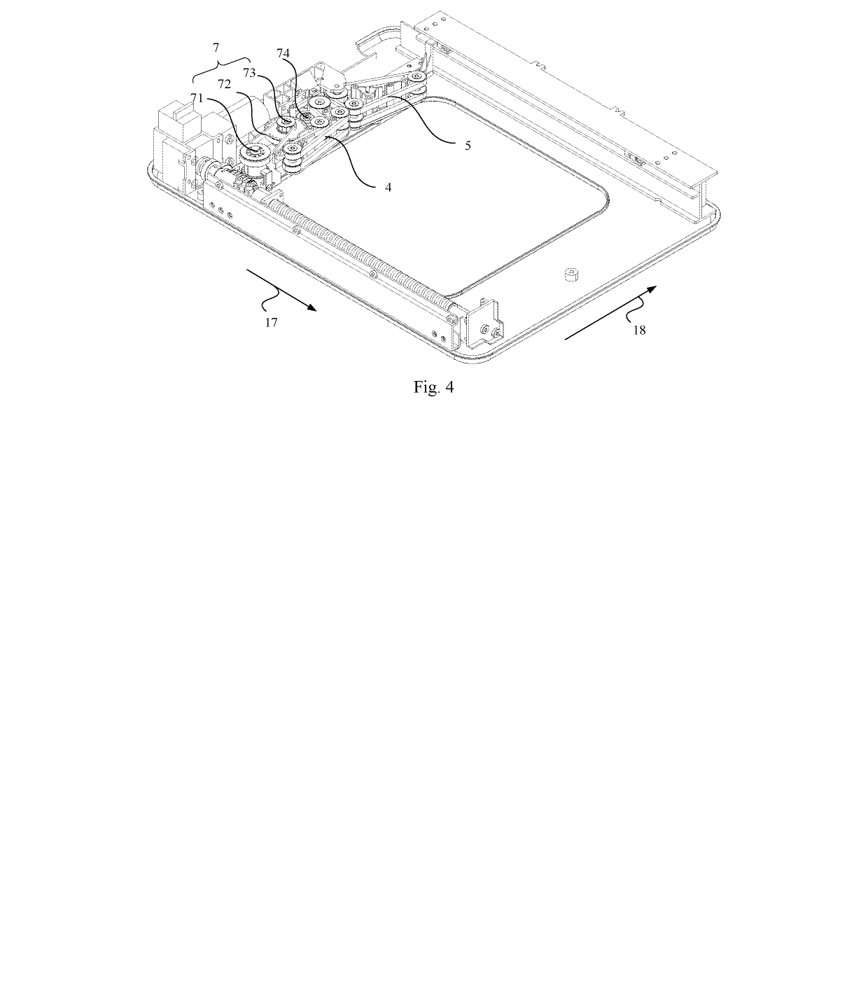

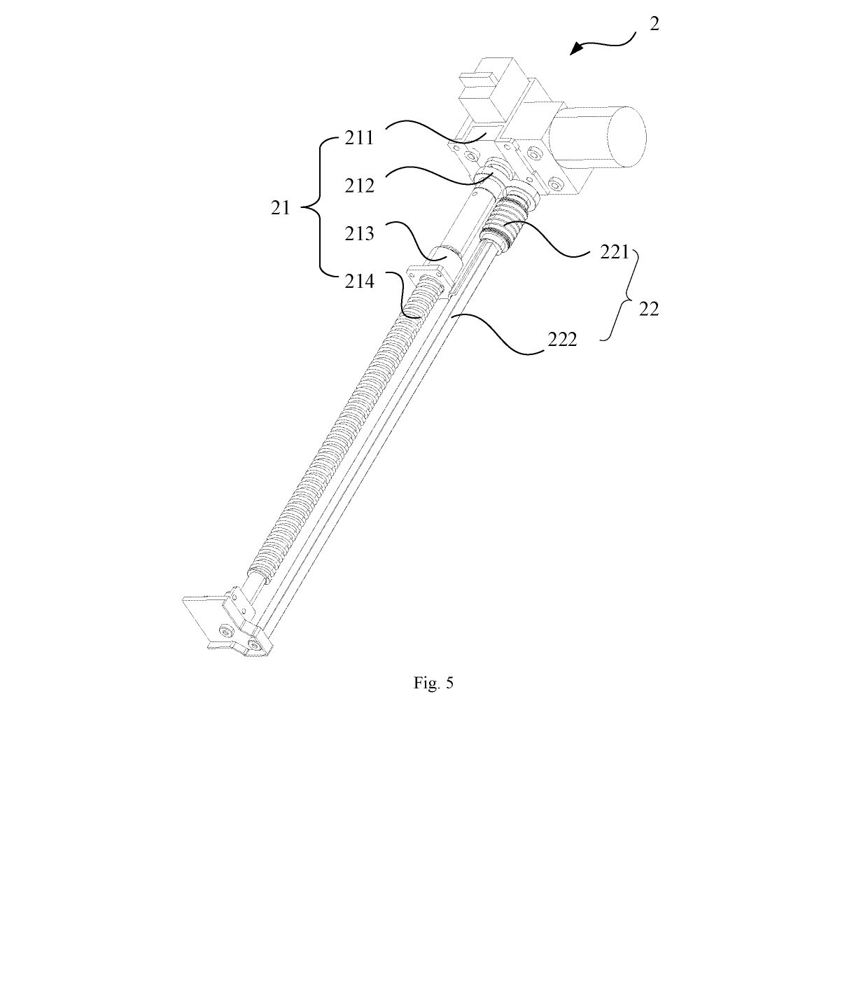

As shown in FIGS. 1-8, a gathering mechanism includes a first gathering assembly 4 and a second gathering assembly 5. An embodiment of the present disclosure provides a trash can, including a trash can body 1, a driving mechanism 2, a frame assembly 3, the first gathering assembly 4, the second gathering assembly 5, and a heating part 6. Inside the trash can body 1, an accommodating groove 11 and an accommodating chamber 12 are arranged spaced apart from each other in a vertical direction within the trash can body 1. The accommodating groove 11 is located below the accommodating chamber 12. The accommodating chamber 12 is configured to receive a trash bag. An edge on an inner side of the accommodating chamber 12 is provided with an opening to allow the trash bag to extend outward. The driving mechanism 2 is provided in the accommodating groove 11 along a first direction 17. The frame assembly 3 is provided in the accommodating groove 11 along a second direction 18 perpendicular to the first direction 17. The frame assembly 3 is connected to the driving mechanism 2. The driving mechanism 2 is configured to drive the frame assembly 3 to reciprocate along the first direction 17. The first gathering assembly 4 and the second gathering assembly 5 are provided within the frame assembly 3. The frame assembly 3 is driven by the driving mechanism 2 to cause the first gathering assembly 4 and the second gathering assembly 5 to move along the first direction 17. The first gathering assembly 4 is drivably connected to the driving mechanism 2, and the second gathering assembly 5 is drivably connected to the first gathering assembly 4, thereby enabling synchronous rotation of the first gathering assembly 4 and the second gathering assembly 5. At least partial regions of the first gathering assembly 4 and the second gathering assembly 5 are in contact with each other to gather and close the trash bag into a contact region between the first gathering assembly 4 and the second gathering assembly 5. The heating part 6 is provided within the first gathering assembly 4 or the second gathering assembly 5, and is configured perform heat sealing on the trash bag.

In the present disclosure, by providing the driving mechanism 2 and the frame assembly 3, and the first gathering assembly 4 and the second gathering assembly 5 are provided inside the frame assembly 3, the driving mechanism 2 is configured to drive the first gathering assembly 4 and the second gathering assembly 5 to move along the first direction 17. The driving mechanism 2 is drivably connected to the first gathering assembly 4, and the first gathering assembly 4 is drivably connected to the second gathering assembly 5, such that the first gathering assembly 4 is configured to rotate about an outer peripheral wall of the first gathering assembly 4, and the second gathering assembly 5 is configured to rotate about an outer peripheral wall of the second gathering assembly 5. As the frame assembly 3 moves along the first direction 17, the first gathering assembly 4 and the second gathering assembly 5 are driven to continuously approach the trash bag, thereby continuously gathering the trash bag into the contact region between the first gathering assembly 4 and the second gathering assembly 5. The heating part 6 then performs heat sealing on the trash bag. Accordingly, in the trash can of the present disclosure, during a closure process of the trash bag, the first gathering assembly 4 and the second gathering assembly 5 approach the trash bag from two sides, and gather the two sides of the trash bag into the contact region between the first gathering assembly 4 and the second gathering assembly 5. The trash bag is gathered and closed, and heat-sealed simultaneously. During the closure process, excessive folds at the opening of the trash bag can be avoided, making a thickness of the trash bag opening more uniform. The thickness of the trash bag opening during heat sealing is much smaller than that of the trash bag opening gathered and closed in the prior art, thereby enabling more sufficient and uniform melting and improving the sealing effect of the trash bag, while reducing the possibility of air leakage or cracking at the seal.

In some embodiments, the first gathering assembly 4 and the second gathering assembly 5 are connected to each other only at a rear central portion thereof through a support.

In some embodiments, the first direction 17 is a width direction of the trash can body 1, and the second direction 18 is a length direction of the trash can body 1; or the first direction 17 is the length direction of the trash can body 1, and the second direction 18 is the width direction of the trash can body 1. In this embodiment, the first direction 17 is the width direction of the trash can body 1, and the second direction 18 is the length direction of the trash can body 1.

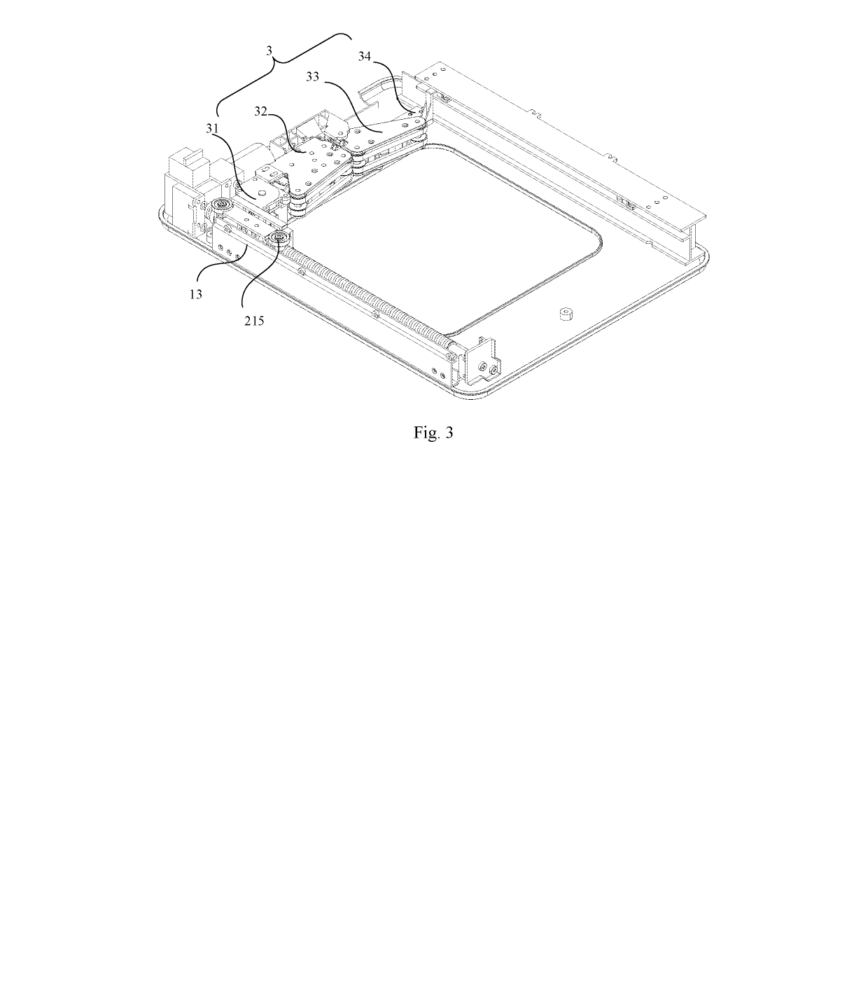

Referring to FIG. 3, the frame assembly 3 includes a first frame 31, a second frame 32, and a third frame 33 that are connected to each other. The driving mechanism 2 is partially provided within the first frame 31. The first gathering assembly 4 is provided within the second frame 32. The second gathering assembly 5 is provided within the third frame 33.

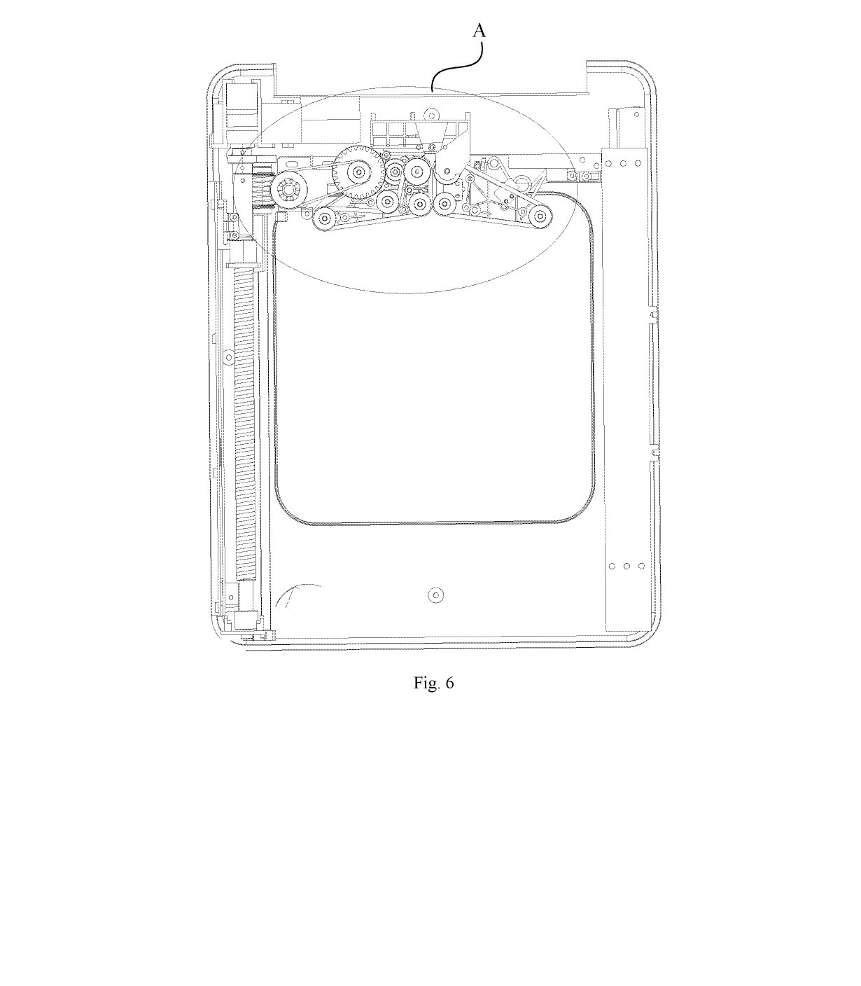

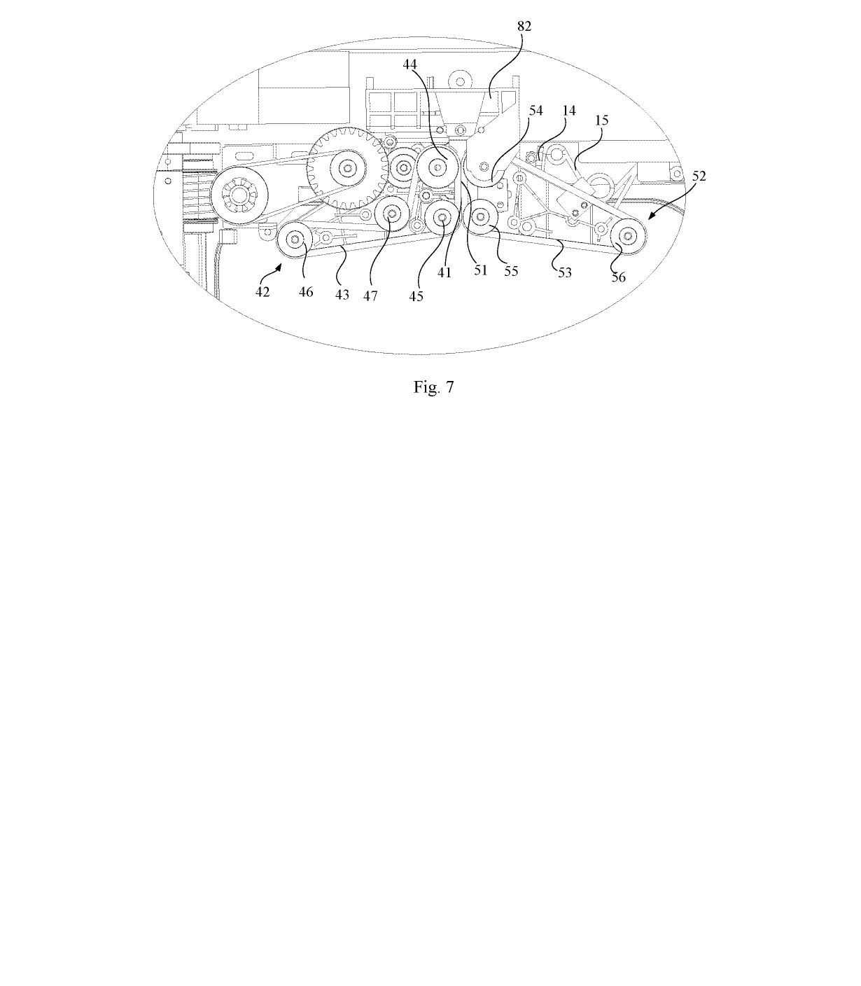

In some embodiments, referring to FIGS. 6-7, the first gathering assembly 4 includes a first contact region 41, and the second gathering assembly 5 includes a second contact region 51. The first contact region 41 and the second contact region 51 are in contact with each other to gather and close the trash bag between the first contact region 41 and the second contact region 51.

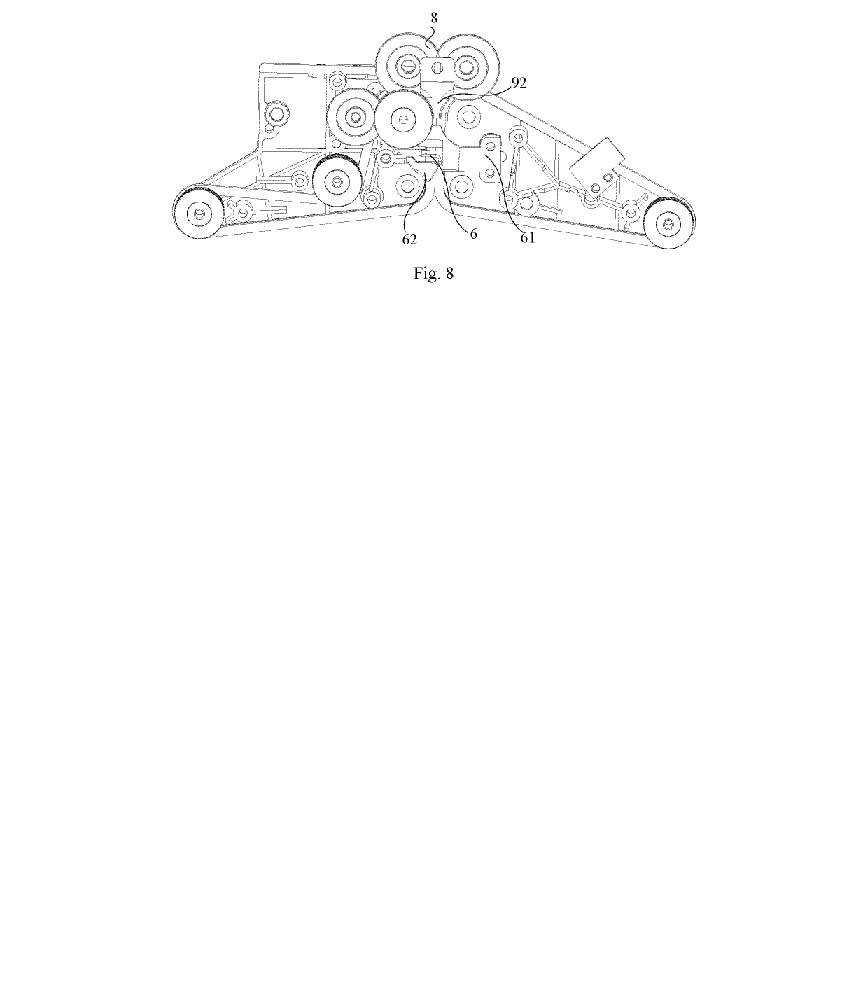

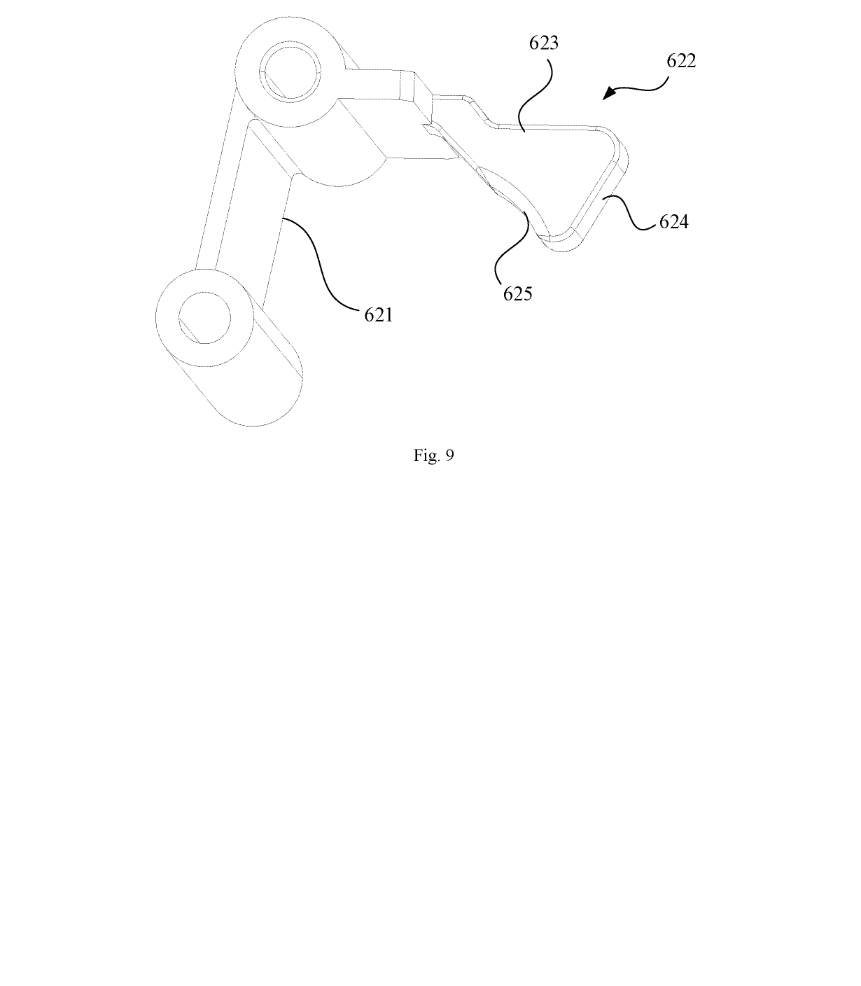

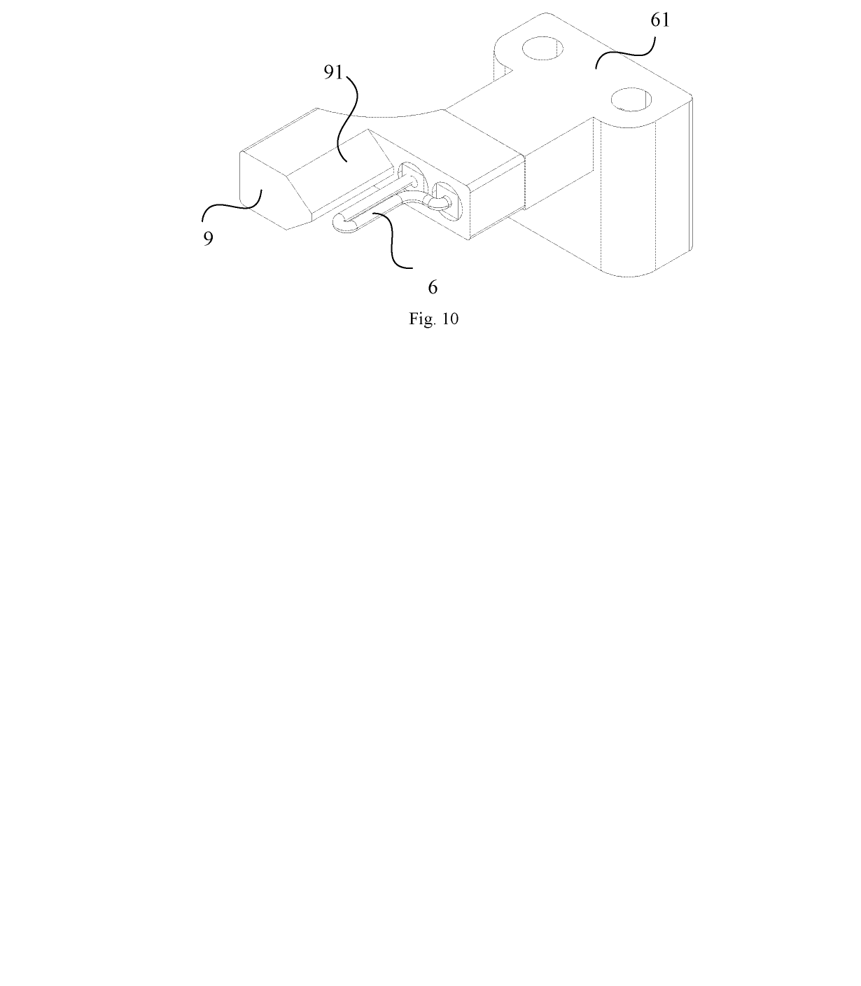

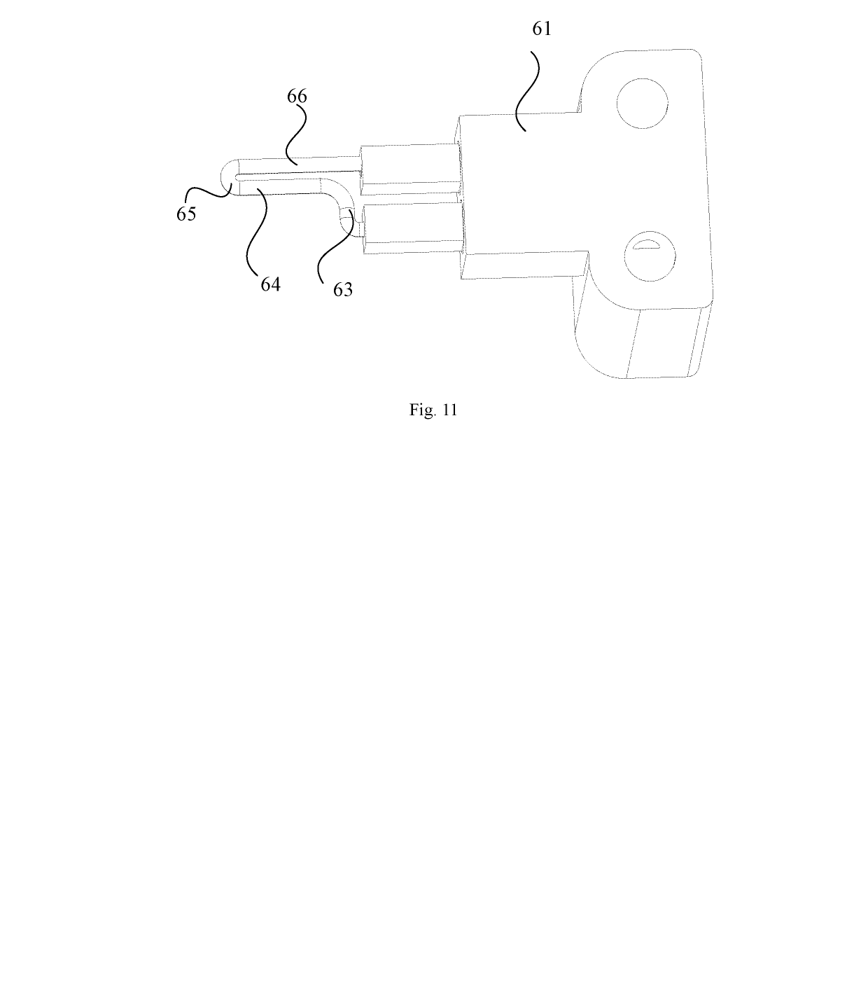

Referring to FIGS. 8-11, the trash can of the present disclosure further includes a mounting portion 61. The mounting portion 61 is provided on inner bottom surface of the third frame 33. The heating part 6 is provided on a side of the mounting portion 61 facing the first gathering assembly 4. The heating part 6 is fixedly provided within the third frame 33 through the mounting portion 61, and is configured to extend out of the second gathering assembly 5.

The trash can of the present disclosure further includes an abutting mechanism 62 provided within the second frame 32. The abutting mechanism 62 is arranged spaced apart from the first contact region 41 in the height direction of the trash can body 1, and is configured to protrude out of the first contact region 41 toward the second contact region 51. During the closure of the trash bag, gaps exist between the two sides of the trash bag. By providing the abutting mechanism 62 to press against the trash bag, the gaps between the two sides of the trash bag after being brought together are reduced. This allows the trash bag to fit closely during the closure process, enabling the bag opening to be welded uniformly and airtight during heat sealing, thereby further improving the sealing performance of the trash bag.

In some embodiments, the abutting mechanism 62 is provided adjacent to a center of the trash can body 1 with respect to the heating part 6.

In some embodiments, the abutting mechanism 62 includes a positioning portion 621 and a protruding portion 622. The positioning portion 621 is provided on an inner bottom surface of the second frame 32, and the protruding portion 622 is provided on a side of the positioning portion 621. The protruding portion 622 is arranged spaced apart from the first contact region 41 in a height direction of the trash can, and is configured to protrude out of the first contact region 41 toward the second contact region 51.

In some embodiments, the protruding portion 622 includes a first edge 623 and a second edge 624. The first edge 623 is arranged parallel to the width direction of the trash can body 1, and the second edge 624 is configured to be inclined with respect to the first edge 623. In some embodiments, an end of the second edge 624 away from the first edge 623 is configured to extend obliquely toward the second gathering assembly 5 until it connects with the first edge 623. The second edge 624 is smoothly connected to the first edge 623 in an arc shape to prevent the junction between the first edge 623 and the second edge 624 from piercing the opening of the trash bag.

In some embodiments, the second edge 624 is configured to extend obliquely through the first contact region 41 and the second contact region 51.

The protruding portion 622 further includes a third edge 625. A first end of the third edge 625 is connected to the first edge 623, and a second end of the third edge 625 is connected to the second edge 624. The first edge 623, the second edge 624 and the third edge 625 are configured to enclose a substantially triangular shape.

The heating part 6 includes a first bending portion 63, a first heating portion 64, a second bending portion 65 and a second heating portion 66. An end of the first bending portion 63 is insertedly provided in the mounting portion 61. The second bending portion 65 is configured to extend along the width direction of the trash can body 1 away from the protruding portion 622, and is connected to an end of the first heating portion 64. The first heating portion 64 is configured to extend in the length direction of the trash can body 1 away from the mounting portion 61, and is connected to a first end of the second bending portion 65. A first end of the second heating portion 66 is insertedly provided in the mounting portion 61, and a second end of the second heating portion 66 is connected to a second end of the second bending portion 65.

In some embodiments, the heating part 6 is configured to protrude out of the second contact region 51. The first heating portion 64 and the second bending portion 65 are configured to protrude out of the second contact region 51. The second heating portion 66 is configured to partially protrude out of the second contact region 51.

Referring to FIGS. 1-7, the driving mechanism 2 includes a driving assembly 21 and a first transmission assembly 22. The driving assembly 21 and the first transmission assembly 22 are provided within the accommodating groove 11 along the first direction 17. An end of the frame assembly 3 is connected to the driving assembly 21. The driving assembly 21 is configured to drive the frame assembly 3 to reciprocate along the first direction 17. The first transmission assembly 22 is partially provided inside the frame assembly 3. The first transmission assembly 22 is drivably connected to the driving assembly 21. The first transmission assembly 22 is drivably connected to the first gathering assembly 4.

The driving assembly 21 includes a motor 211, a second transmission assembly 212, a lead screw 213 and a lead screw nut 214. A first end of the second transmission assembly 212 is connected to the motor 211, and a second end of the second transmission assembly 212 is connected to the lead screw 213. The lead screw nut 214 is threadedly connected to the lead screw 213. The frame assembly 3 is connected to the lead screw nut 214. The motor 211 is configured to drive the second transmission assembly 212 to rotate, thereby driving the lead screw 213 to rotate, which in turn causes the lead screw nut 214 to reciprocate along the lead screw 213. The lead screw nut 214 is configured to drive the frame assembly 3 to move along the first direction 17.

In some embodiments, the driving assembly 21 further includes a guide wheel 215. The guide wheel 215 is connected to the frame assembly 3. A guide rail 13 is provided within the accommodating groove 11 along the first direction 17. The guide wheel 215 is slidably connected to the guide rail 13.

The first transmission assembly 22 includes a worm gear 221 and a worm 222. The worm 222 is drivably connected to the second transmission assembly 212. The worm gear 221 is sleeved on the worm 222. The motor 211 is configured to drive the worm 222 to rotate through the second transmission assembly 212, thereby driving the worm gear 221 to rotate. The worm gear 221 is provided within the first frame 31. The frame assembly 3 is configured to drive the worm gear 221 to reciprocate along the worm 222. The worm gear 221 is drivably connected to the first gathering assembly 4.

In some embodiments, the worm 222 is a square shaft.

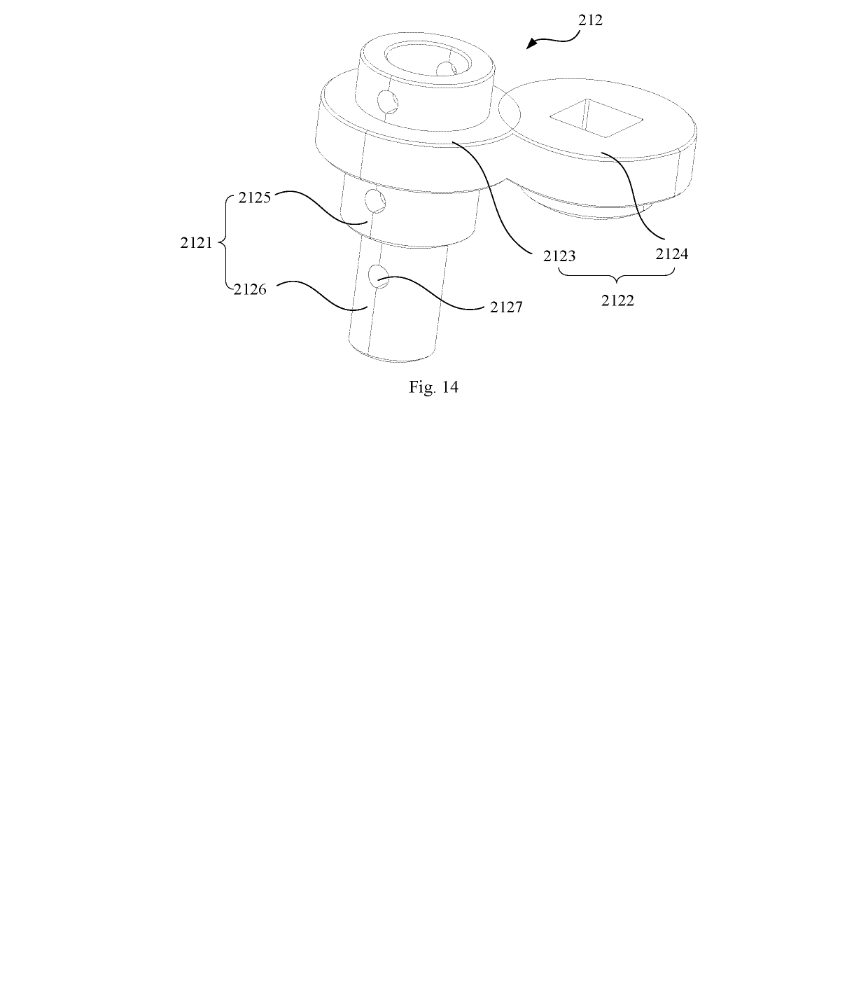

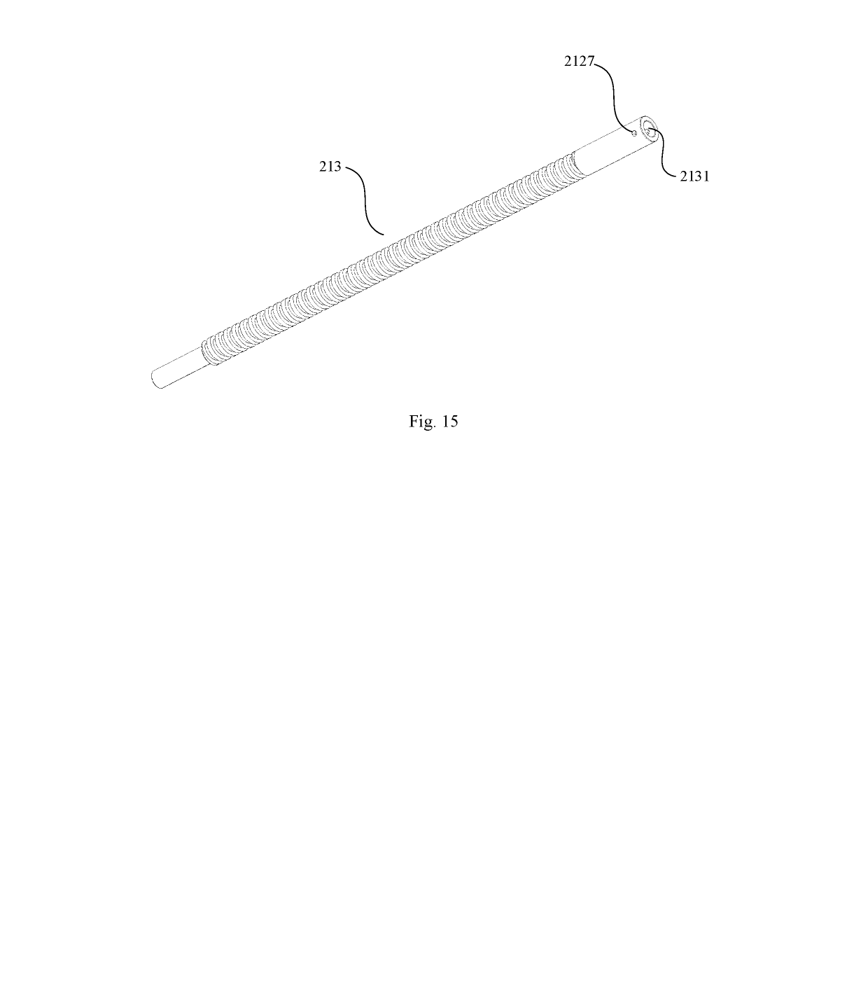

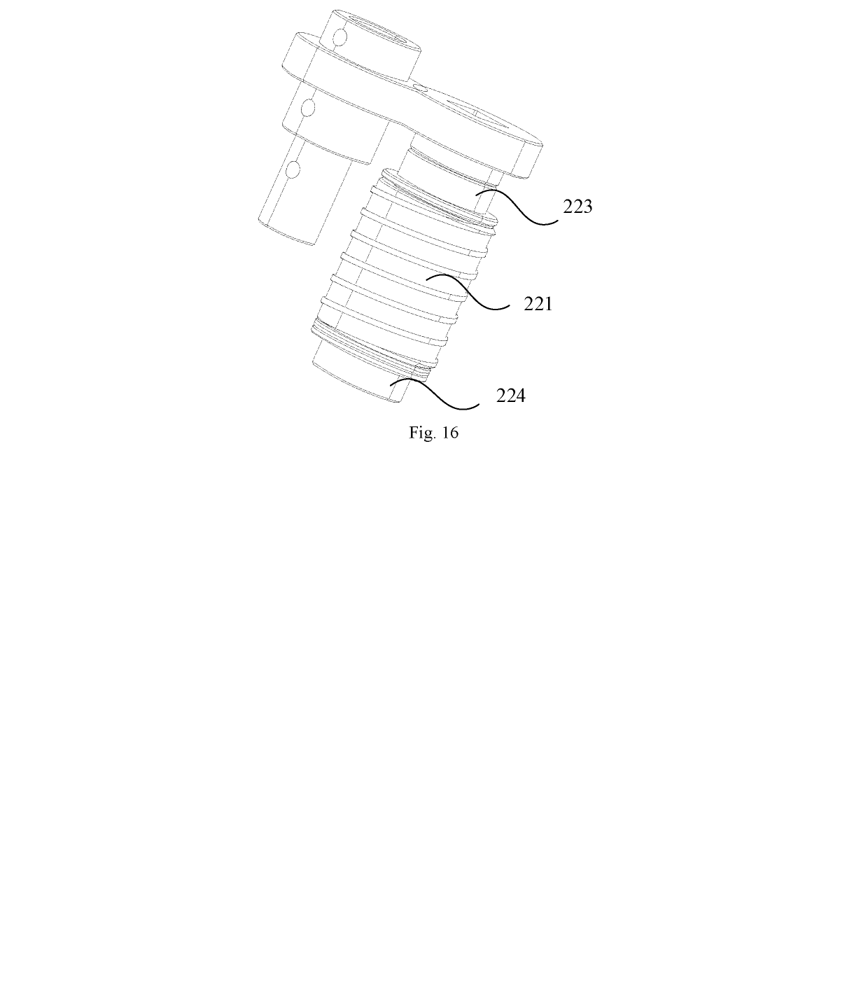

Referring to FIGS. 14-16, the second transmission assembly 212 includes a transmission shaft 2121 and a transmission gear set 2122. A first end of the transmission shaft 2121 is connected to an output shaft of the motor 211, and a second end of the transmission shaft 2121 is connected to the lead screw 213. The transmission gear set 2122 is fixedly sleeved outside the transmission shaft 2121, and is drivably connected to the worm 222.

The transmission gear set 2122 includes a first transmission gear 2123 and a second transmission gear 2124. The first transmission gear 2123 is fixedly sleeved outside the transmission shaft 2121. The second transmission gear 2124 is fixedly provided at an end of the worm 222. The first transmission gear 2123 is engaged with the second transmission gear 2124 to achieve synchronous rotation.

The transmission shaft 2121 includes a first connecting segment 2125 and a second connecting segment 2126. A diameter of the first connecting segment 2125 is greater than a diameter of the second connecting segment 2126. The first transmission gear 2123 is fixedly sleeved around the first connecting segment 2125. An end of the lead screw 213 is provided with an insertion slot 2131. The second connecting segment 2126 is configured to be inserted into the insertion slot 2131.

The driving assembly 21 further includes a first connecting part and a connecting hole 2127. The connecting hole 2127 is configured to penetrate through the lead screw 213 and the second connecting segment 2126. The first connecting part is insertedly provided in the connecting hole 2127 to fixedly connect the second connecting segment 2126 and the lead screw 213. In some embodiments, the first connecting part is a screw or a bolt.

The first transmission assembly 22 further includes a first bearing 223 and a second bearing 224. The first bearing 223 and the second bearing 224 are both sleeved outside the worm 222. The first bearing 223 is provided at a first end of the worm gear 221, and the second bearing 224 is provided at a second end of the worm gear 221. The first bearing 223 is provided between the second transmission gear 2124 and the worm gear 221. By providing the first bearing 223 and the second bearing 224, the worm gear 221 can rotate smoothly.

In the present disclosure, the motor 211 is configured to drive the lead screw 213 to rotate, thereby driving the lead screw nut 214, the frame assembly 3 and the worm gear 221 to move along the first direction 17. The motor 211 is drivably connected to the worm 222, such that the motor 211 is configured to drive the worm 222 to rotate, thereby driving the worm gear 221 to rotate. Accordingly, the worm gear 221 is configured to perform reciprocating movement and rotation, so as to approach and gather and close the garbage bag. By employing a single power source, the motor 211, instead of multiple power sources as in conventional transmission systems, the present disclosure reduces the use of multiple power units, simplifies the system structure, lowers manufacturing costs, and prevents energy waste, thereby achieving energy conservation and environmental protection.

Referring to FIGS. 1-7, the trash can of the present disclosure further includes a synchronous pulley set 7 provided within the second frame 32. The synchronous pulley set 7 includes a first synchronous pulley 71, a second synchronous pulley 72 and a synchronous belt 73. The first synchronous pulley 71 and the second synchronous pulley 72 are arranged spaced apart from each other within the second frame 32. The first synchronous pulley 71 is engaged with the worm gear 221. The second synchronous pulley 72 is drivably connected to the first gathering assembly 4. The worm gear 221 is configured to drive the first synchronous pulley 71 to rotate. The synchronous belt 73 is sleeved around the first synchronous pulley 71 and the second synchronous pulley 72, thereby enabling synchronous rotation of the first synchronous pulley 71 and the second synchronous pulley 72.

Referring to FIGS. 3-7, the trash can of the present disclosure further includes an idler gear 74. The idler gear 74 is provided between the second synchronous pulley 72 and the first gathering assembly 4. The second synchronous pulley 72 is configured to drive the first gathering assembly 4 to rotate through the idler gear 74.

In some embodiments, the synchronous pulley set 7, the idler gear 74 and the first gathering assembly 4 are provided within the second frame 32.

The first gathering assembly 4 includes a first driving wheel set 42 and a first transmission belt 43. The first driving wheel set 42 is drivably connected to the idler gear 74. The first transmission belt 43 is sleeved over the first driving wheel set 42. The first transmission belt 43 is driven by the first driving wheel set 42to move along an outer periphery of the first driving wheel set 42.

In some embodiments, the first driving wheel set 42 includes a first driving wheel 44, a second driving wheel 45 and a third driving wheel 46. The first transmission belt 43 is sleeved over outer peripheries of the first driving wheel 44, the second driving wheel 45 and the third driving wheel 46. The first driving wheel 44 is drivably connected to the idler gear 74. The first driving wheel 44, the second driving wheel 45 and the third driving wheel 46 are configured to enclose to form a triangle.

In this embodiment, the first driving wheel 44 includes two pulleys and a gear. The gear is provided between the two pulleys, and is coaxially aligned with the two pulleys. The second driving wheel 45 is formed by two coaxially arranged pulleys of the same size. The third driving wheel 46 is formed by two coaxially arranged pulleys of the same size. The number of the first transmission belt 43 is two. The number of the first driving wheel 44 is two. The number of the second driving wheel 45 is two. The number of the third driving wheel 46 is two. One of two first transmission belts 43 is sleeved around one of two first driving wheels 44, one of two second driving wheels 45 and one of two third driving wheels 46; while the other of the two first transmission belts 43 is sleeved around the other of the two first driving wheels 44, the other of the two second driving wheels 45 and the other of the two third driving wheels 46. The idler gear 74 is engaged with a middle gear of the first driving wheel 44 for transmission.

The first driving wheel set 42 further includes a tensioning wheel 47. An outer periphery of the tensioning wheel 47 is configured to abut against the first transmission belt 43.

In some embodiments, the first driving wheel 44 and the second driving wheel 45 are aligned with each other at edges adjacent to the second gathering assembly 5.

In some embodiments, the protruding portion 622 is located between the first driving wheel 44 and the second driving wheel 45, and is positioned within a gap formed between the two first transmission belts 43. By providing the two first transmission belts 43, the area for gathering the trash bag is increased. The protruding portion 622 and the heating part 6 are arranged within the gap formed between the two first transmission belts 43, allowing the heat-sealing portion of the trash bag and the remaining bag body to be separated.

Referring to FIG. 7, the second gathering assembly 5 includes a second driving wheel set 52 and a second transmission belt 53. The second driving wheel set 52 is drivably connected to the first driving wheel set 42. The second transmission belt 53 is sleeved around the second driving wheel set 52. The second transmission belt 53 is driven by the second driving wheel set 52 to move along an outer periphery of the second driving wheel set 52. The first contact region 41 is located on the first transmission belt 43, and the second contact region 51 is located on the second transmission belt 53.

In some embodiments, the second driving wheel set 52 includes a first transmission wheel 54, a second transmission wheel 55 and a third transmission wheel 56. The second transmission belt 53 is sleeved around outer peripheries of the first transmission wheel 54, the second transmission wheel 55 and the third transmission wheel 56. The first transmission wheel 54 is drivably connected to the first driving wheel 44. The first transmission wheel 54, the second transmission wheel 55 and the third transmission wheel 56 are configured to enclose to form a triangle.

In some embodiments, the first transmission wheel 54 and the second transmission wheel 55 are aligned at their edges. An edge of the first transmission belt 43 adjacent to the second gathering assembly 5 is parallel to and in close contact with an edge of the second transmission belt 53 adjacent to the first gathering assembly 4, thereby forming the first contact region 41 and the second contact region 51.

In some embodiments, the first driving wheel 44 and the first transmission wheel 54 have the same size; the second driving wheel 45 and the second transmission wheel 55 have the same size; and the third driving wheel 46 and the third transmission wheel 56 have the same size, such that rotational speeds of the first driving wheel set 42 and the second driving wheel set 52 are the same.

In this embodiment, the first transmission wheel 54 includes two pulleys and a gear. The gear is provided between the two pulleys, and is coaxially aligned with the two pulleys. The second transmission wheel 55 is formed by two coaxially arranged pulleys of the same size. The third transmission wheel 56 is formed by two coaxially arranged pulleys of the same size. The number of the second transmission belt 53 is two. The number of the first transmission wheel 54 is two. The number of the second transmission wheel 55 is two. The number of the third transmission wheel 56 is two. One of two second transmission belts 53 is sleeved around one of two first transmission wheels 54, one of two second transmission wheels 55 and one of two third transmission wheels 56, while the other of the two second transmission belts 53 is sleeved around the other of the two first transmission wheels 54, the other of the two second transmission wheels 55, and the other of the two third transmission wheels 56.

In some embodiments, the heating part 6 is provided between the first transmission wheel 54 and the second transmission wheel 55, and is located in a gap formed between the two second transmission belts 53.

The trash can of the present disclosure further includes a rear wheel set 8 provided within the frame assembly 3. The rear wheel set 8 is provided between the first driving wheel 44 and the first transmission wheel 54. The first transmission wheel 54 is drivably connected to the first driving wheel 44 through the rear wheel set 8.

In this embodiment, the number of the rear wheel 81 is two. A first side of a first rear wheel 81 of two rear wheels 81 is engaged with the middle gear of the first driving wheel 44, and a second side of the first rear wheel 81 of the two rear wheels 81 is engaged with a first side of a second rear wheel 81 of the two rear wheels 81. A second side of the second rear wheel 81 of the two rear wheels 81 is engaged with a middle gear of the first transmission wheel 54.

The trash can of the present disclosure further includes a rear support block 82. The rear wheels 81 are rotatably provided within the rear support block 82. The rear support block 82 is connected to the second frame 32 and the third frame 33. The second frame 32 drives the rear support block 82 to move in the first direction 17, thereby driving the rear wheels 81 to move in the first direction 17, and the rear support block 82 further drives the third frame 33 to move in the first direction 17.

The trash can of the present disclosure further includes a first pushing ramp 9. The first pushing ramp 9 is provided on the side of the mounting portion 61 facing the first gathering assembly 4. The first pushing ramp 9 is arranged spaced apart from the heating part 6, and is located on a side of the heating part 6 away from the center of the trash can body 1. The first pushing ramp 9 has two first slopes 91 that together form a cutting edge, with one of the two first slopes 91 being arranged above and the other of the two first slopes 91 arranged below. A cutting edge formed at an intersection of the two first slopes 91 is oriented toward the heating part 6. As the frame assembly 3 moves along the first direction 17, the two first slopes 91 enable the separation of the adjacent upper and lower trash bags.

The trash can of the present disclosure further includes a second pushing ramp 92. The second pushing ramp 92 is provided on the rear support block 82, and is arranged spaced apart from the first pushing ramp 9. The second pushing ramp 92 is located on a side of the first pushing ramp 9 away from the heating part 6. The second pushing ramp 92 has a second slope 93 that is substantially parallel to the first slope 91 located above. The second slope 93 is configured to guide the adjacent upper and lower trash bags, after being heat-sealed, to move toward a rear side of the heating wire, thereby preventing accumulation of the trash bags.

In some embodiments, the second pushing ramp 92 includes two pushing arms 94 and a second connecting part 95. The two pushing arms 94 are symmetrically arranged in the vertical direction. The second connecting part 95 is provided between the two pushing arms 94. Each pushing arm 94 is provided with the second slope 93. Two pushing arms 94 and the second connecting part 95 are integrally formed.

In some embodiments, each pushing arm 94 includes a pushing portion 941, a fixing portion 942 and a clamping portion 943. The pushing portion 941 is connected to the fixing portion 942. The fixing portion 942 is arranged horizontally. The pushing portion 941 is configured to be inclined with respect to the fixing portion 942. The fixing portion 942 is provided with a fixing hole 944. The second pushing ramp 92 is fixedly connected to the rear support block 82 via a fixing part insertedly provided in the fixing hole 944. The clamping portion 943 is provided at a middle of each of two sides of the pushing portion 941. The two rear wheels 81 are respectively provided within two clamping portions 943.

The second pushing ramp 92 further includes a retaining edge 96 provided on a side of each pushing arm 94. In some embodiments, the number of the retaining edges 96 is two. Two retaining edges 96 are respectively arranged on two sides of the second slope 93, such that the opening of the trash bag continues to move along the second slope 93 and is thereby completely cut off.

By providing the first pushing ramp 9 and the second pushing ramp 92, the present disclosure enables complete separation of the opening of the trash bag from the remaining portion of the bag.

Referring to FIG. 7, the trash can of the present disclosure further includes a sensor 14 provided within the accommodating groove 11. The frame assembly 3 further includes a fourth frame 34. A first end of the fourth frame 34 is connected to the third frame 33, and a second end of the fourth frame 34 is slidably connected to a side wall of the accommodating groove 11. The fourth frame 34 is driven by the third frame 33 to move along the first direction 17. The fourth frame 34 is located below the third frame 33. The sensor 14 is mounted on the fourth frame 34. A first end of the third frame 33 is rotatably connected to the rear support block 82 via a rotating shaft. The rotating shaft is coaxially aligned with the first transmission wheel 54. The third frame 33 and the second gathering assembly 5 are configured to rotate about the rotating shaft. When there is a protrusion inside the trash bag that hinders bag packing, the protrusion causes the second gathering assembly 5 and the third frame 33 to rotate together about the rotating shaft in a direction away from the first gathering assembly 4. When the third frame 33 rotates to contact the sensor 14, the sensor 14 transmits a signal, causing the trash can to issue an alert.

In some embodiments, the trash can of the present disclosure further includes a return spring 15. A first end of the return spring 15 is connected to a side wall of the trash can body 1, and a second end of the return spring 15 is connected to a second end of the third frame 33. After the trash can issues the alert, an operator can remove the protrusion, allowing the third frame 33 and the second gathering assembly 5 to return to their original positions under the action of the return spring 15, thereby restoring normal operation of the trash can.

The trash can of the present disclosure further includes a controller 16 provided in the trash can body 1. The controller 16 is electrically connected to the motor 211 and the sensor 14. The controller 16 is configured to control the operation of the motor 211 and to receive signals transmitted from the sensor 14 in order to issue an alert.

Described above are merely preferred embodiments of the present disclosure, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. A driving mechanism for a trash can, comprising:
a frame assembly;
a driving assembly;
a gathering assembly; and
a first transmission assembly;
wherein the driving assembly comprises a motor, a lead screw and a lead screw nut;
the motor is connected to the lead screw;
the lead screw nut is threadedly connected to the lead screw, and is connected to the frame assembly;
the motor is configured to drive the lead screw to rotate to cause the lead screw nut to reciprocate along the lead screw, so as to drive the frame assembly to move along a first direction to approach a trash bag;
the gathering assembly is provided on the frame assembly along a second direction perpendicular to the first direction;
the first transmission assembly is arranged spaced apart from the driving assembly;
the first transmission assembly comprises a worm gear and a worm;
the worm is drivably connected to the motor;
the worm gear is sleeved on the worm, and is drivably connected to the gathering assembly;
the motor is configured to drive the worm to rotate to cause the worm gear to rotate, so as to drive the gathering assembly to gather and close the trash bag;
the worm gear is provided inside the frame assembly; and
the frame assembly is configured to drive the worm gear to reciprocate along the worm.

2. The driving mechanism of claim 1, further comprising:
a second transmission assembly;
wherein a first end of the second transmission assembly is connected to the motor, and a second end of the second transmission assembly is connected to the lead screw; and
the second transmission assembly is drivably connected to the worm.

3. The driving mechanism of claim 2, wherein the second transmission assembly comprises a transmission shaft and a transmission gear set;
a first end of the transmission shaft is connected to the motor, and a second end of the transmission shaft is connected to the lead screw;
the transmission gear set is sleeved outside the transmission shaft; and
the transmission gear set is drivably connected to the worm.

4. The driving mechanism of claim 3, wherein the transmission gear set comprises a first transmission gear and a second transmission gear;
the first transmission gear is sleeved outside the transmission shaft;
the second transmission gear is provided at an end of the worm; and
the first transmission gear is engaged with the second transmission gear.

5. The driving mechanism of claim 4, wherein the transmission shaft comprises a first connecting segment and a second connecting segment;
a diameter of the first connecting segment is greater than a diameter of the second connecting segment;
the first transmission gear is fixedly sleeved on the first connecting segment;
an end of the lead screw is provided with an insertion slot; and
the second connecting segment is configured to be inserted into the insertion slot.

6. The driving mechanism of claim 5, wherein the driving assembly further comprises a connecting part and a connecting hole;
the connecting hole is configured to penetrate through the lead screw and the second connecting segment; and
the connecting part is insertedly provided in the connecting hole to fix the second connecting segment to the lead screw.

7. The driving mechanism of claim 4, wherein the first transmission assembly further comprises a first bearing and a second bearing;
the first bearing and the second bearing are sleeved outside the worm;
the first bearing is provided at a first end of the worm gear, and the second bearing is provided at a second end of the worm gear; and
the first bearing is provided between the second transmission gear and the worm gear.

8. The driving mechanism of claim 1, wherein the driving assembly further comprises a guide wheel; and the guide wheel is provided on the frame assembly.
